(19) United States
(12) Patent Application Publication
(10) Pub. No.: US 2009/0032553 A1
(43) Pub. Date: Feb. 5, 2009

(54) PERSONAL MULTI-USE DEODORIZER

(76) Inventor: Sheree Eddy, Huntington Beach, CA (US)

Correspondence Address: ADVANTIA LAW GROUP, 9035 SOUTH 1300 EAST, SUITE 200, SANDY, UT, 84094, US

(21) Appl. No.: 12/132,083

(22) Filed: Jun. 3, 2008

Related U.S. Application Data
(60) Provisional application No. 60/953,017, filed on Jul. 31, 2007.

(51) Int. Cl. B67D 5/06; B67D 1/07

(52) U.S. Cl. 222/192; 222/183

(57) ABSTRACT

A personal multi-use deodorizer device may comprise a housing having a cavity therein. The device may also include a top container hingedly coupled to a top portion of the housing; wherein the top container includes a selectively closable aperture. The device may further include a bottom container coupled to the bottom of the housing, wherein the bottom container may include a selectively closable aperture having an air-tight seal. The device may also include a fluid container disposed within the cavity of the housing and having a fluid dispensing device extending outwardly from a top portion of the housing. The fluid container may be selectably removable from the housing. Finally, the device may include a mirror disposed on a side portion of the housing; wherein the mirror may be selectably coupleable.

### CROSS-REFERENCE TO RELATED APPLICATIONS

This invention claims priority, under 35 U.S.C. § 120, to the United States Provisional Patent Application No. 60/953,017 to Eddy filed on Jul. 31, 2007, which is incorporated by reference herein.

### BACKGROUND OF THE INVENTION

1. Field of the Invention

The present invention relates to deodorizers, specifically a personal multi-use deodorizer.

2. Description of the Related Art

As recent advancement in quality of life proceeds, the problem of bad smell originating from individual bodies such as foul breath and body odor has become a matter of great concern. Such a problem has greatly affected even personal relations. This, there have been a variety of mouth wash liquids for removing or preventing foul breath. However, most of these mouth wash liquids often contain ingredients undesirable for internal use and the use thereof is restricted to the deodorizing of the mouth.

Various body areas of the skin contain sweat glands that produce perspiration, or sweat, on the surface of the skin. Various metabolic or biological processes play a role in the production of perspiration including temperature regulation, physical activity or exertion, emotional stress such as anger, fear, and excitement, hormonal fluctuations, menopause, medicinal effects, and disease. Perspiration produced by the sweat glands appears on the surface of the epidermis, which constitutes the outermost layer of the skin. The sweat glands themselves are found in the reticular region of the dermis, the layer of the skin located just beneath the epidermis. Some skin areas of the body perspire more profusely than others, one reason being the higher density or concentration of sweat glands in some skin areas of the body. Furthermore, some skin areas of the body where perspiration is produced have only limited exposure to light and/or air due to their anatomical location and/or their being normally covered by clothing.

Although perspiration by itself is essentially an odorless fluid, the degradation or decomposition of perspiration by the bacterial organisms on the skin causes an offensive odor, commonly referred to as body odor, to be produced. Dead skin cells mixed in with the perspiration are also subject to degradation and decomposition by the bacterial organisms, and may exacerbate body odor. The underarms and feet provide an optimal environment for the production of body odor in that a larger population of bacterial organisms may be available to effect degradation or decomposition of perspiration, a greater quantity of perspiration may be available for degradation or decomposition by the bacterial organisms, degradation or decomposition of perspiration into body odor may occur at a faster rate due to the larger population of bacterial organisms and/or the greater quantity of perspiration, and/or degradation or decomposition of perspiration into body odor may occur over a longer period of time due to the conditions favorable to the production of body odor being sustained for relatively long periods of time. Some improvements have been made in the field. Examples of references related to the present invention are described below, and the supported teachings of each reference are incorporated by reference herein:

U.S. Pat. No. 5,819,989, issued to Saraceni, discloses a combination dispenser for dispensing a cleaning solution and sheets of paper toweling from a roll. The combination dispenser comprises a container and a liquid dispensing fixture releasably secured to the container. The container has a neck portion and an integral base portion, which together form a chamber for receiving and storing a cleaning solution. The neck portion, which extends perpendicularly from and centrally of the base portion, is disposed to be inserted through the cardboard tube of a paper towel roll, rotatably to support the roll on the dispenser. A trigger-type spray nozzle has a cap for threaded engagement with the top of the neck portion to seal the container. The trigger-type spray nozzle also comprises a hose extending into the container for carrying the cleaning solution to the spray nozzle. A retaining member also is provided to prevent unraveling of paper towels from the roll. The invention may be scaled down in size, for use and storage on an automobile, boat, etc.

U.S. Pat. No. 6,926,166, issued to Bitton et al., discloses a product combining individual novelty candy dispensers and health and beauty dispensers into a single device. In one embodiment a lip balm dispenser is combined with a breath spray dispenser into a single product. In another embodiment, a lip embodiment a lip balm dispensers is combined with a candy dispenser into a single product. In a third embodiment, a candy dispenser, breath spray dispenser and lip balm dispenser are all combined into one product.

U.S. Pat. No. 5,156,275, issued to Murray Sr., discloses a cosmetic bottle compact consisting of a set of generally rectangularly configured compartments, disposed to form a case body having an integrated exterior surface, each of the compartments having an opening disposed in a common surface of the case body and being closed along any other exterior surface thereof, at least a first compartment constructed and arranged in the case body for its inside configuration to accommodate a cosmetic bottle having its outside configuration conforming to the inside configuration of the first compartment, at least a second compartment constructed and arranged in the case for its inside configuration to accommodate stacked money or change having its outside configuration conforming to the inside configuration of the second compartment, at least a third compartment constructed and arranged in the case body for its inside configuration to accommodate a lipstick having its outside configuration conforming to the inside configuration of the third compartment, a mirror of plastic construction disposed on a generally flat portion of the exterior surface of the case body, a key ring affixed to the case body, and an alarm or defensive component affixed onto another portion of the exterior surface of the case body.

U.S. Pat. No. 6,431,405, issued to Irwin, discloses a system combining a fluid dispenser and a pop-up sheet dispenser. The fluid dispenser is a bottle with a spray pump, while the sheet dispenser is a tub with an opening through which sheets pop out. The two dispensers snap together to trap and store sheets from a longitudinally folded web ready for pop-out dispensing. The primary embodiment may be used for spray cleaner and paper towels, for example. The sheet dispenser provides the system's base, dispensing from a roll with its core held vertically in the tub, located by the tub's core-locating hub. The fluid dispenser snaps vertically down into the sheet dispenser, acting as its lid and further locating the roll with its hub-stem. The roll, held loosely by the two hubs, may spin within the system. The tub, opening, and roll may together rotate relative to the fluid dispenser to reorient the opening. In a secondary embodiment, the sheet dispenser dispenses from a stack held vertically between the bottle and the tub which are side-by-side and snap together horizontally. Again, the bottle acts as a lid for the tub. A tertiary embodiment demonstrates how the primary embodiment may be reapplied to other products, such as cosmetic fluids and sheets.

U.S. Pat. No. 5,848,731, issued to Deering, discloses a dispensing device designed to be secured to a container, and to perform a cap function for the container. The dispenser is particularly designed to retain and dispense a plurality of different personal care items, such as lip-balm, lotions or cosmetics when the container is filled with fluids such as water or body lotion, or semi-solids such as sunscreen or skin creams. The dispenser includes a cup-shaped body having an inner annular wall interconnected to an outer annular wall by a circular bottom wall, the walls together defining a storage chamber in which to retain balm, cosmetics, condiments or other such substances. The inner wall of the body has internal threads for threadably engaging the dispenser with the neck of the container, the dispenser thus serving as the cap for the container. The dispenser further includes a capping lid that is releasably engaged over the body. The capping lid has a circular top wall with an annular sidewall depending from it. A centrally-located spout seal is positioned on the circular top wall of the capping lid so that when the lid is positioned over the body, it not only covers the body's storage chamber, but it also seals the opening in the container, thus preventing fluid from being emitted from the container when the lid is in place.

U.S. Pat. No. 7,018,473, issued to Shadrach III, discloses a dispenser to dispense towels selectively treated with a fluid, includes a compartment having an open upper end and containing at least one dispensable towel therein. A removable cover is disposable on the compartment to form an enclosure with the compartment. A towel dispensing conduit extends through the cover to a top opening of the cover, the conduit defining a path through which the dispensable towel is extracted from the compartment and dispensed from the top opening of the cover. A fluid application assembly is associated with the removable cover. The fluid application assembly includes a fluid reservoir, oriented over the compartment when the cover is disposed on the compartment, and being configured to receive and store the fluid therein; and a fluid applicator, in fluid communication with the reservoir and being selectively operable by a user to selectively apply the fluid to the dispensable towel as the towel is dispensed from the dispenser.

U.S. Pat. No. 5,520,202, issued to Arbree, discloses a thin, flat miniature cosmetic kit made of plastic and designed to hold in separate compartments a one-day supply of perfume, lipstick and face powder and an applicator for the cosmetics. The cosmetic kit has a self-locking cover which when closed prevents the scattering or loss of the cosmetics when the kit is closed and locked.

The inventions heretofore known suffer from a number of disadvantages which include being bulky, being expensive, being limited in application, being limited in versatility, being awkward to use, and being unsanitary.

What is needed is a personal multi-use deodorizer that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available a personal multi-use deodorizer. Accordingly, the present invention has been developed to provide a convenient and effective device to remove odor.

A personal multi-use deodorizer device may comprise a housing having a cavity therein. The device may also include a top container hingedly coupled to a top portion of the housing; wherein the top container includes a selectively closable aperture. The top container may also include a cavity disposed on an underside of the top container configured to receive a fluid dispensing device, and wherein the top container may cover the fluid dispensing device when in a closed mode. In addition, the top container may be replaceable. The device may further include a bottom container coupled to the bottom of the housing, wherein the bottom container may include a selectively closable aperture having an air-tight seal. The bottom container may also include a support system supporting a dowel. The bottom container may also be replaceable.

The device may further include a fluid container disposed within the cavity of the housing and having a fluid dispensing device extending outwardly from a top portion of the housing. The fluid container may be selectably removable from the housing; wherein the fluid container may include breath deodorizing fluid. The bottom container may include a roll of textile material disposed about the dowel, and the top container may include a plurality of edible breath deodorizing tablets. Finally, the device may include a mirror disposed on a side portion of the housing; wherein the mirror may be selectably coupleable.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not therefore to be considered to be limiting of its scope, the invention will be described and explained with additional specificity and detail through the use of the accompanying drawing(s), in which:

FIG. 1 is a perspective view of a multi-use deodorizer, according to one embodiment of the invention;

FIG. 2 is a perspective view of a multi-use deodorizer, according to one embodiment of the invention;

FIG. 3 is a perspective view of a multi-use deodorizer, according to one embodiment of the invention; and

FIG. 4 is a cross sectional view of a multi-use deodorizer, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment or example is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

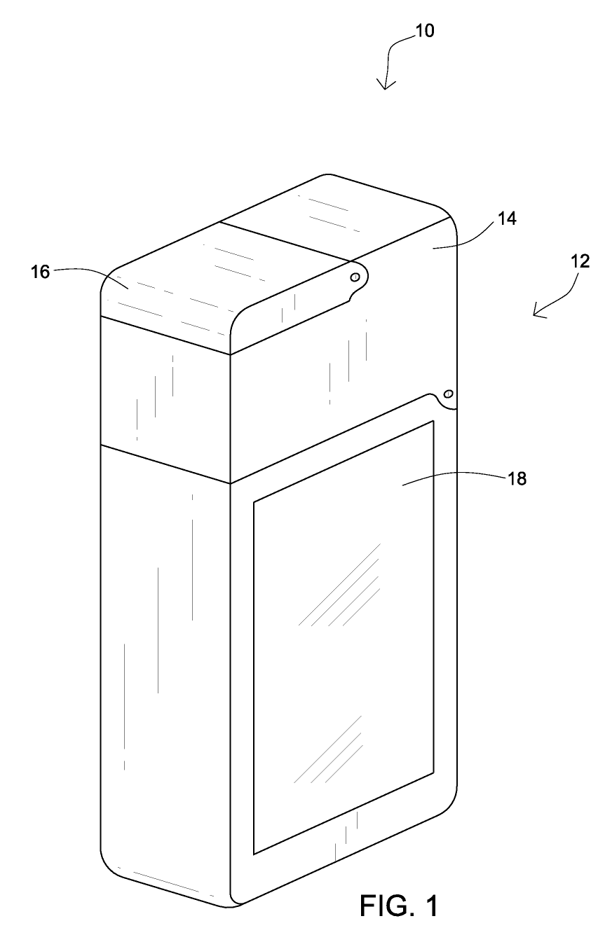

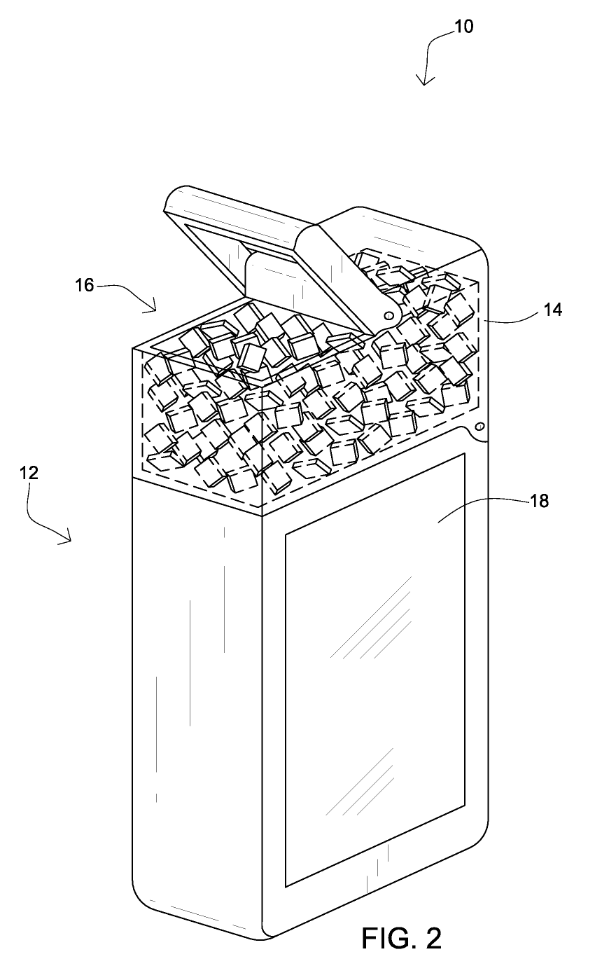

FIGS. 1 and 2 illustrate a multi-use deodorizer 10 configured to provide an all-in-one compact air, clothing, breathe, and hand deodorizer, according to one embodiment of the invention, wherein the deodorizer 10 includes a housing 12. The housing 12 includes a top compartment 14, wherein the top compartment 14 is hingedly coupled to the housing 12. The top compartment 14 includes a selectably sealable aperture 16, wherein the top compartment 14 is configured to store deodorizing mints. The housing 12 also includes a mirror 18 coupled to an exterior side of the housing 12.

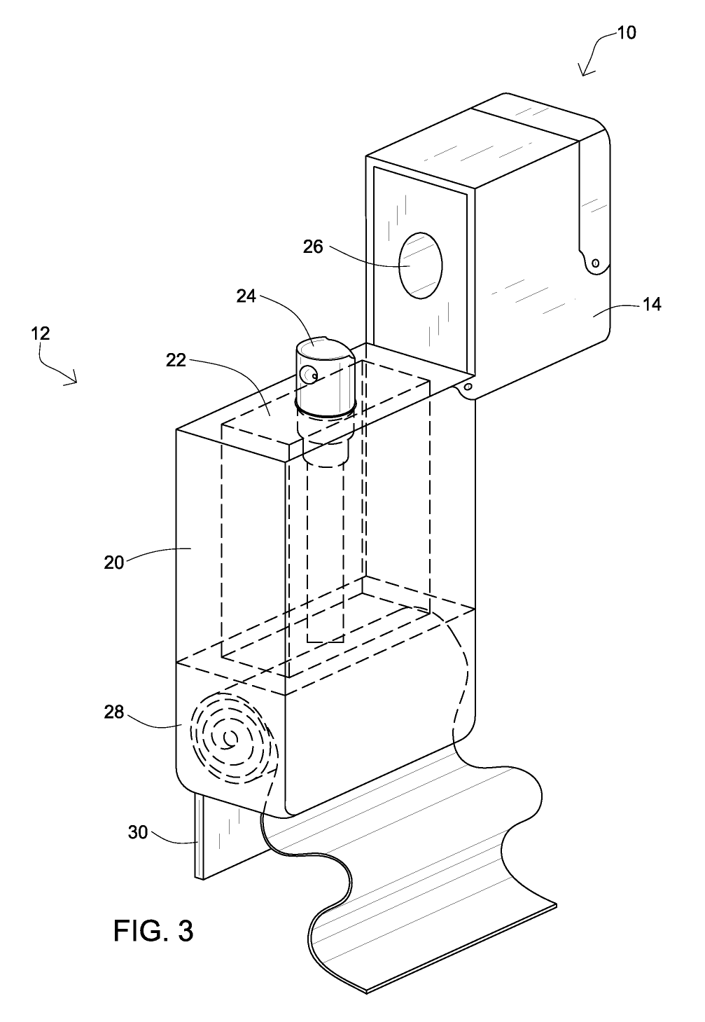

FIG. 3 illustrates a multi-use deodorizer 10, according to one embodiment of the invention, wherein the deodorizer 10 includes a housing 12 and a top compartment 14. The housing 12 also includes a middle compartment 20, wherein the middle compartment 20 is configured to store a fluid container 22 and a fluid dispensing device 24. The fluid dispensing device 24 and the fluid container 22 are configured to be selectably removable from the housing 12. The top compartment 14 includes an aperture 26 coupled to an underside of the top compartment 14 configured to store the fluid dispensing device 24 in a closed mode. The housing 12 also includes a bottom compartment 28, wherein the bottom compartment 28 is configured to store and dispense deodorizing wipes. The bottom compartment 28 also includes a selectably sealable cover 30, wherein the cover 30 creates an air tight seal of the bottom compartment 28.

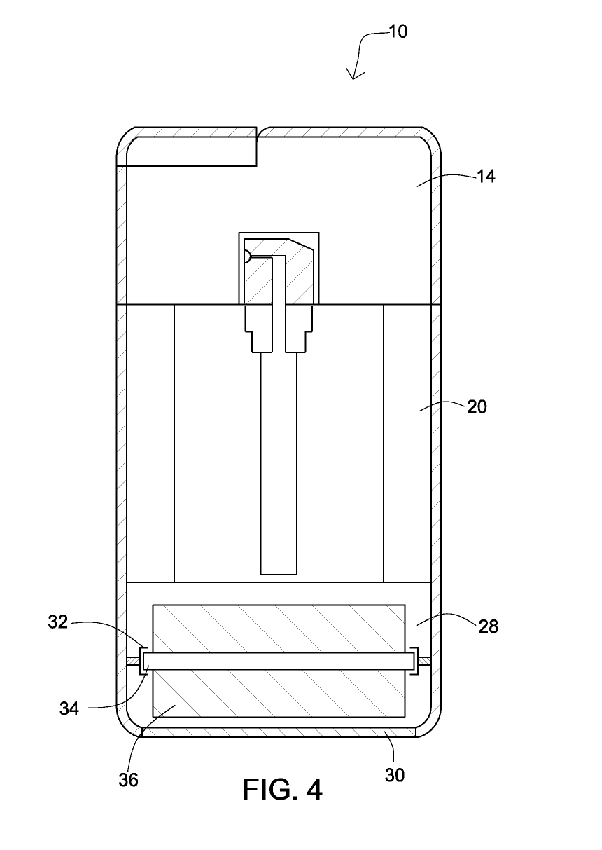

FIG. 4 illustrates a multi-use deodorizer 10, according to one embodiment of the invention, wherein the deodorizer 10 includes a housing 12, a top, middle, and bottom compartment 14, 20, and 28. As illustrated the bottom compartment 28 includes a support system 32, wherein the support system 32 is configured to support a dowel 34. The dowel 34 is configured to support a roll of textile material 36.

In operation of the multi-use deodorizer 10, a user may open the top compartment 14 of the multi-use deodorizer 10 and retrieve an edible breathe deodorizing tablet. The selectably closeable aperture 16 may be closed to secure the edible breathe deodorizing tablets in the top compartment. A middle compartment 20 may be opened upon lifting the top compartment about its pivot, disposing a fluid dispensing device 24. The fluid dispensing device 24 is in fluid communication with the fluid container 22, and when the fluid dispensing device 24 is actuated an air deodorizer (clothing deodorizer) is displaced. Furthermore, a roll of textile material 36 (deodorizing wipes) may be retrieved by opening the cover 30. This deodorizer 10 allows for an all-in-one air, breathe, clothing, and hand sanitizing deodorizer in a convenient and easy to use apparatus.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope. For example, although the figures illustrate breathe deodorizers in the shape of pills, one skilled in the art would appreciate that the breathe deodorizers may be any shape, design, color, size, composition and still perform its intended function.

Additionally, although the figures illustrate one inch by one inch hand sanitizing and deodorizing wipes, one skilled in the art would appreciate that the wipes may be any shape, design, color, configuration, size, and concentration and still perform its intended function. One non-limiting example may be the wipes disposed like a Kleenex container, wherein the wipe that is retrieved is substantially coupled to the next wipe to be retrieved, thereby creating an easy dispensing mechanism.

It is also envisioned that the mirror disposed on the exterior of the multi-use deodorizer housing may be displaced anywhere about the multi-use deodorizer housing and still perform its intended function. Furthermore, the mirror may vary in size, shape, design, and configuration and still perform its intended function. It is further envisioned that the edible breath deodorizing tablets may be breath deodorizing gum and still perform its intended function.

It is expected that there could be numerous variations of the design of this invention. An example is that the multi-use deodorizer housing, top compartment, middle compartment, bottom compartment, fluid container, fluid dispensing device may be any shape, size, design, configuration, and color and still perform its intended function.

Finally, it is envisioned that the components of the device may be constructed of a variety of materials, such as plastic, metal, metal alloys, rubber, rubber compositions or any other combination thereof.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. A personal multi-use deodorizer device, comprising:
a) a housing;
b) a top container hingedly coupled to a top portion of the housing;
c) a bottom container coupled to the bottom of the housing, wherein the bottom container includes an selectively closable aperture having an air-tight seal;
d) a fluid container disposed within the housing and having a fluid dispensing device extending outwardly from a top portion of the housing; and
e) a mirror disposed on a side portion of the housing.

2. The device of claim 1, wherein the top container includes a selectively closable aperture.

3. The device of claim 2, wherein the fluid container is selectably removable from the housing.

4. The device of claim 3, wherein the top container includes a cavity disposed on an underside of the top container configured to receive the fluid dispensing device, and wherein the top container covers the fluid dispensing device when in a closed mode.

5. The device of claim 4, wherein the bottom container includes a support system supporting a dowel.

6. The device of claim 5, wherein the fluid container includes deodorizing fluid, the bottom container includes a roll of textile material disposed about the dowel, and the top container includes a plurality of edible breath deodorizing tablets.

7. The device of claim 6, wherein the top container is replaceable.

8. The device of claim 7, wherein the bottom container is replaceable.

9. The device of claim 8, wherein the mirror is selectably coupleable.

10. A personal multi-use deodorizer device, comprising:
a) a housing having a cavity therein;
b) a top container hingedly coupled to a top portion of the housing;
c) a bottom container coupled to the bottom of the housing, wherein the bottom container includes an selectively closable aperture having an air-tight seal;
d) a fluid container disposed within the cavity of the housing and having a fluid dispensing device extending outwardly from a top portion of the housing; and
e) a mirror disposed on a side portion of the housing.

11. The device of claim 10, wherein the top container includes a selectively closable aperture.

12. The device of claim 10, wherein the fluid container is selectably removable from the housing.

13. The device of claim 10, wherein the top container includes a cavity disposed on an underside of the top container configured to receive the fluid dispensing device, and wherein the top container covers the fluid dispensing device when in a closed mode.

14. The device of claim 10, wherein the bottom container includes a support system supporting a dowel.

15. The device of claim 10, wherein the fluid container includes deodorizing fluid, the bottom container includes a roll of textile material disposed about the dowel, and the top container includes a plurality of edible breath deodorizing tablets.

16. The device of claim 10, wherein the top container is replaceable.

17. The device of claim 10, wherein the bottom container is replaceable.

18. The device of claim 10, wherein the mirror is selectably coupleable.

19. A personal multi-use deodorizer device, comprising:
a) a housing having a cavity therein;
b) a top container hingedly coupled to a top portion of the housing; wherein the top container includes a selectively closable aperture; wherein the top container includes a cavity disposed on an underside of the top container configured to receive a fluid dispensing device, and wherein the top container covers the fluid dispensing device when in a closed mode; wherein the top container is replaceable;
c) a bottom container coupled to the bottom of the housing, wherein the bottom container includes an selectively closable aperture having an air-tight seal; wherein the bottom container includes a support system supporting a dowel; wherein the bottom container is replaceable;
d) a fluid container disposed within the cavity of the housing and having a fluid dispensing device extending outwardly from a top portion of the housing; wherein the fluid container is selectably removable from the housing; wherein the fluid container includes deodorizing fluid, the bottom container includes a roll of textile material disposed about the dowel, and the top container includes a plurality of edible breath deodorizing tablets; and
e) a mirror disposed on a side portion of the housing; wherein the mirror is selectably coupleable.
